(19) United States
(12) Patent Application Publication
(10) Pub. No.: US 2023/0284020 A1
(43) Pub. Date: Sep. 7, 2023

(54) HANDLING OF USER EQUIPMENT IN EPS AND 5GS SUPPORTING USER PLANE INTEGRITY PROTECTION

(71) Applicant: Telefonaktiebolaget LM Ericsson (publ), STOCKHOLM (SE)

(72) Inventors: Monica Wifvesson, LUND (SE); Mikael Wass, SÄTILA (SE)

(21) Appl. No.: 18/019,744

(22) PCT Filed: Jul. 8, 2021
(86) PCT No.: PCT/IB2021/056108

§ 371 Date: Feb. 3, 2023

Related U.S. Application Data
(60) Provisional application No. 63/061,976, filed on Aug. 6, 2020.

(51) Int. Cl. H04W 12/08; H04W 12/106

(52) U.S. Cl. CPC H04W 12/08; H04W 12/106

(57) ABSTRACT

A network node in a wireless communication system configures an operator policy to indicate whether to accept legacy user equipments, UEs, that do not support user plane integrity protection, UP IP, and it sets UP IP to be either “preferred” or “not required” of a UP security policy based on the operator policy indicating acceptance of legacy UEs and in response to a communication related to a legacy UE.

### TECHNICAL FIELD

The present disclosure relates to wireless communication systems and more particularly to providing access stratum security between user equipments and communication networks.

### BACKGROUND

The 3GPP TS 23.401 V16.7.0 standard describes the 4G network architecture. A simplified version of 4G network is shown in FIG. 1 where a single eNodeB (eNB) for LTE is connected to a Mobility Management Entity or Function (MME) node.

The User Equipment (UE) is a mobile device used by the user to wirelessly access the network. The radio access network (RAN) function or base station called LTE eNB is responsible for providing wireless radio communication to the UE and connecting the UE to the core network. The core network function called MME is responsible for handling mobility of the UE, among other responsibilities, and also handling session and traffic steering of the UE, among other responsibilities. Yet another core network function called Serving Gateway (SGW) is responsible for interconnecting to data network via Packet Data Network (PDN) Gateway, packet routing and forwarding, among other responsibilities.

The UE interacts with the LTE eNB over-the-air via a radio interface. Radio interface traffic comprises of both control plane traffic and user plane traffic. The radio control plane comprises Radio Resource Control (RRC) signaling, for example. The LTE eNB in turn interacts with the MME using the interface called the S1-MME Similarly, the LTE eNB and the SGW interact using the interface called the S1-U.

Logical aspects for communications between the UE and the MME are referred to as non-access stratum (NAS). Logical aspects for communications between the UE and the LTE-eNB are referred to as access stratum (AS). Correspondingly, the security of communication (control plane and user plane, if applicable) are referred to as NAS security and AS security, respectively. AS security comprises confidentiality and integrity protection of both control plane (i.e., the RRC) and user plane traffic, which are further explained below. The radio bearers in AS that carry control plane or the RRC messages are called signaling radio bearers (SRBs). Similarly, radio bearers in AS that carry user plane messages are called dedicated radio bearers (DRBs).

In LTE systems, AS security is mandatory for both the RRC and the user plane. Such AS security means that both the confidentiality and the integrity protection are activated for the RRC and the confidentiality is activated for the user plane. However, there is no support for user plane integrity protection in LTE PDCP in Rel-15 UE and in a Rel-15 LTE eNB.

LTE includes null-encryption and null-integrity algorithms that do not encrypt and integrity protect RRC or user plane traffic in practice. However, such null algorithms are just another kind of algorithm and therefore the AS security is still said to be activated, albeit using null algorithms.

If support of integrity protection for user plane is to be introduced in an EPS/LTE system, then such support needs to be introduced by modifying operation of UE, MME and eNB, in order to be able to activate user plane integrity protection. The EPS/LTE system should be able to continue to provide reliable service to legacy UEs not supporting user plane integrity protection, legacy MMEs not supporting user plane integrity protection, and eNBs not supporting user plane integrity protection.

This also applies to 5GS if user plane integrity protection is introduced in ng-eNB. Such support needs to be introduced in UEs and ng-eNBs. It is noted that AMF can already support user plane integrity protection.

### SUMMARY

In certain embodiments, a method of operating a network node in a wireless communication system comprises configuring an operator policy to indicate whether to accept legacy user equipments, UEs, that do not support user plane integrity protection, UP IP, and setting UP IP to be either “preferred” or “not required” of a UP security policy based on the operator policy indicating acceptance of legacy UEs and in response to a communication related to a legacy UE.

In certain related embodiments, the configuring of the operator policy is performed by a mobility management entity, MME, and the setting of the UP IP is responsive to receiving a PDN connection establishment request of the legacy UE.

In certain related embodiments, the method further comprises communicating the UP IP policy setting to an LTE eNB based on the operator policy indicating acceptance of legacy UEs.

In certain related embodiments, the configuring of the operator policy is performed by a home subscriber server, HSS, and the setting of the UP IP is responsive to receiving a check policy request indicating whether the legacy UE supports UP IP or not. In some such embodiments, the method further comprises sending a check policy response containing the UP security policy responsive to the check policy request.

In certain related embodiments, the configuring of the operator policy is performed by a home subscriber server, HSS, and sets the UP IP in the UP security policy to “preferred” or “not required,” and prevents the UP IP in the UP security policy from being set to “required.” In some such embodiments, the method further comprises sending a check policy response containing the UP IP of the UP security policy responsive to receiving a check policy request.

In certain related embodiments, the method further comprises initiating a MME to reject handover of a PDN connection request from the legacy UE based on the UP IP of the UP security policy being set to “required.”

In certain related embodiments, the configuring of the operator policy is performed by a session management function, SMF, and the setting of the UP IP is responsive to receiving (402) a PDU session establishment request of the legacy UE. In some such embodiments, the method further comprises communicating the UP IP policy setting to a ng-eNB based on the operator policy indicating acceptance of legacy UEs.

In certain related embodiments, the configuring of the operator policy is performed by a unified data management, UDM, and the setting of the UP IP is responsive to receiving a policy request from a session management function, SMF, indicating whether the legacy UE supports UP IP or not. In some such embodiments, the method further comprises sending a policy response containing the UP security policy to the SMF responsive to the policy request.

In some embodiments, a network node comprises at least one processor and memory collectively configured to configure an operator policy to indicate whether to accept legacy user equipments, UEs, that do not support user plane integrity protection, UP IP, and set UP IP to be either “preferred” or “not required” of a UP security policy based on the operator policy indicating acceptance of legacy UEs and in response to a communication related to a legacy UE.

In certain related embodiments, the network node comprises a mobility management entity, MME, and the setting of the UP IP is responsive to receiving a PDN connection establishment request of the legacy UE.

In certain related embodiments, the at least one processor and memory are collectively further configured to communicate the UP IP policy setting to an LTE eNB based on the operator policy indicating acceptance of legacy UEs.

In certain related embodiments, the network node comprises a home subscriber server, HSS, and the setting of the UP IP is responsive to receiving a check policy request indicating whether the legacy UE supports UP IP or not.

In certain related embodiments, the at least one processor and memory are collectively further configured to send a check policy response containing the UP security policy responsive to the check policy request.

In certain related embodiments, the network node comprises a home subscriber server, HSS, and the configuring of the operator policy sets the UP IP in the UP security policy to “preferred” or “not required,” and prevents the UP IP in the UP security policy from being set to “required.” In some such embodiments, the at least one processor and memory are collectively further configured to send a check policy response containing the UP IP of the UP security policy responsive to receiving a check policy request.

In certain related embodiments 20, the at least one processor and memory are collectively further configured to initiate a MME to reject handover of a PDN connection request from the legacy UE based on the UP IP of the UP security policy being set to “required.”

In certain related embodiments, the network node comprises a session management function, SMF, and the setting of the UP IP is responsive to receiving a PDU session establishment request of the legacy UE. In some such embodiments, the at least one processor and memory are collectively further configured to communicate the UP IP policy setting to a ng-eNB based on the operator policy indicating acceptance of legacy UEs.

In certain related embodiments, the network node comprises a unified data management, UDM, and the setting of the UP IP is responsive to receiving a policy request from a session management function, SMF, indicating whether the legacy UE supports UP IP or not. In some such embodiments, the at least one processor and memory are collectively further configured to send a policy response containing the UP security policy to the SMF responsive to the policy request.

### BRIEF DESCRIPTION OF THE DRAWINGS

The accompanying drawings, which are included to provide a further understanding of the disclosure and are incorporated in a constitute a part of this application, illustrate certain non-limiting embodiments of inventive concepts. In the drawings:

FIG. 1 illustrates a simplified 4G network where a single LTE eNB is connected to a MME;

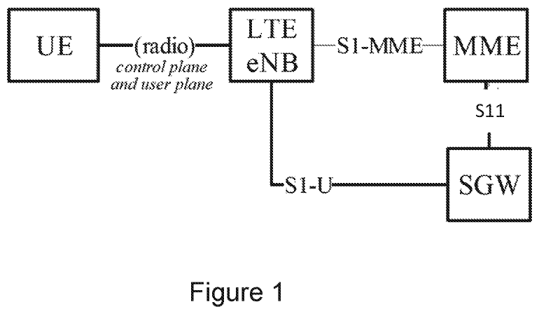

FIG. 2 is a combined flowchart and data flow diagram illustrating operations by an upgraded MME, a HSS, and other elements of a communication system according to some embodiments of the present disclosure;

FIG. 3 is a combined flowchart and data flow diagram illustrating operations by an upgraded MME, a HSS, and other elements of a communication system according to some embodiments of the present disclosure;

FIG. 4 is a combined flowchart and data flow diagram illustrating operations by an upgraded ng-eNB, an upgraded AMF, a SMF, and a UDM, and other elements of a communication system according to some embodiments of the present disclosure; and

FIG. 5 is a block diagram illustrating components of a network node operable according to some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of various present inventive concepts to those skilled in the art. It should also be noted that these embodiments are not mutually exclusive. Components from one embodiment may be tacitly assumed to be present or used in another embodiment.

Embodiments of the present disclosure are directed to operations by various network nodes for handling user plane integrity protection (UP IP) while providing reliable service to legacy UEs not supporting user plane integrity protection, legacy MMEs not supporting user plane integrity protection, and/or eNBs not supporting user plane integrity protection. Some embodiments are further directed to introduction of an operator policy that defines how a UP security policy for UP IP and potentially UP encryption is set. The operator policy may be configured by a MME, Home Subscriber Server (HSS), Session Management Function (SMF), or Unified Data Management (UDM) as will be explained in more detailed regarding various embodiments of the present disclosure. When determined in the MME, the UP security policy may be provided to the LTE eNB over S1 interface. The UP security policy can be selectively set to defined statuses, including but not limited to, Not Needed, Required, or Preferred for UP IP, and the UP security policy applies for the lifetime of the PDN connection. In some embodiments the MME applies and/or requests use of UP IP at PDN Connection establishment (on par with 5GS). UP IP would then be applied per PDN connection lifetime.

The MME may configure a security policy for UP IP, i.e., a UP IP policy, per APN and/or the MME may determine the UP IP policy by potentially retrieving a UP IP policy for the subscription stored in the HSS or from a locally configured UP IP policy. The determined UP IP policy may be configured per UE. The UP IP policy may use similar setting options as in 5GS: “required”, “preferred”, “not needed”.

The MME provides the determined UP IP policy per UE to the LTE eNB on the S1 interface.

The UP security policy is specified in 3GPP TS 33.501 v16.3.0 and 3GPP TS 23.501 v16.5.1, e.g., see clause 5.10.3 in TS 23.501. UP security policy is part of the UP Security enforcement information. For Protocol Data Unit (PDU) Session User Plane Security, the User Plane Security Enforcement information provides the NG-RAN with User Plane security policies for a PDU session. The information indicates:
whether UP integrity protection is:
   Required: for all the traffic on the PDU Session UP integrity protection shall apply.
   Preferred: for all the traffic on the PDU Session UP integrity protection should apply.
   Not Needed: UP integrity protection shall not apply on the PDU Session.
whether UP confidentiality protection is:
   Required: for all the traffic on the PDU Session UP confidentiality protection shall apply.
   Preferred: for all the traffic on the PDU Session UP confidentiality protection should apply.
   Not Needed: UP confidentiality shall not apply on the PDU Session.

User Plane Security Enforcement information may apply only over 3GPP access. Once determined at the establishment of the PDU Session the User Plane Security Enforcement information applies for the life time of the PDU Session.

The Session Management Function (SMF) determines at PDU session establishment User Plane Security Enforcement information for the user plane of a PDU session based on:
subscribed User Plane Security Policy which is part of SM subscription information received from UDM (Unified Data Management); and
User Plane Security Policy locally configured per (DNN, S-NSSAI) in the SMF that is used when the UDM does not provide User Plane Security Policy information.
The maximum supported data rate per UE for integrity protection for the DRBs, provided by the UE in the Integrity protection maximum data rate IE during PDU Session Establishment.

The UP IP policy is part of the UP security policy described above and can indicate whether UP integrity protection is:
Required: for all the traffic on the PDU Session UP integrity protection shall apply.
Preferred: for all the traffic on the PDU Session UP integrity protection should apply.
Not Needed: UP integrity protection shall not apply on the PDU Session.

Embodiments of the present disclosure are now described in the context of alternative operational features that can be performed by various network nodes as described below.

According to a first featured (called “Feature 1), operations can relate to a scenario where a legacy UE not supporting UP IP initiates a Packet Data Network (PDN) connection with a Evolved Packet System/LTE (EPS/LTE) system, and where the MME and eNB have been upgraded to support user plane integrity protection. Such legacy UE could:
(1) be handled by the MME and the eNB in the legacy way as described in Rel-16 specifications and in this case the MME and the eNB cannot activate user plane integrity protection (UP IP) with the legacy UE. This implies that the Home Subscriber Server (HSS) or the MME cannot set UP IP to “required” in the UP security policy for the legacy UE; or
(2) the MME or the HSS could reject the legacy UE by not enabling establishment of a PDN connection.

In accordance with some embodiments, the MME is configured to apply and/or request use of UP IP at PDN Connection establishment (on par with 5GS). A legacy UE which establishes a new PDN connection with an upgraded MME and an upgraded eNB which support UP IP, is operationally handled by the MME and the eNB in the legacy way, and this decision is based upon a configured operator policy. If the configured operator policy allows the upgraded MME/eNB to handle the legacy UE, then the MME or HSS cannot determine a UP IP policy to be “required” since UP IP cannot be activated by the eNB, and the upgraded eNB cannot activate UP IP with the legacy UE for this PDN connection.

In some embodiments this operator policy is configured by operation in the Home Subscriber Server (HSS) or operation in the MME.

As explained above, a “legacy UE” refers to a UE that does not support UP integrity protection. The upgraded MME or the HSS can identify such a UE by checking the ME capability which indicates whether ME supports UP integrity protection or not, and this ME capability is indicated by the UE/ME in an Attach Request message or a Tracking Area Update Request message.

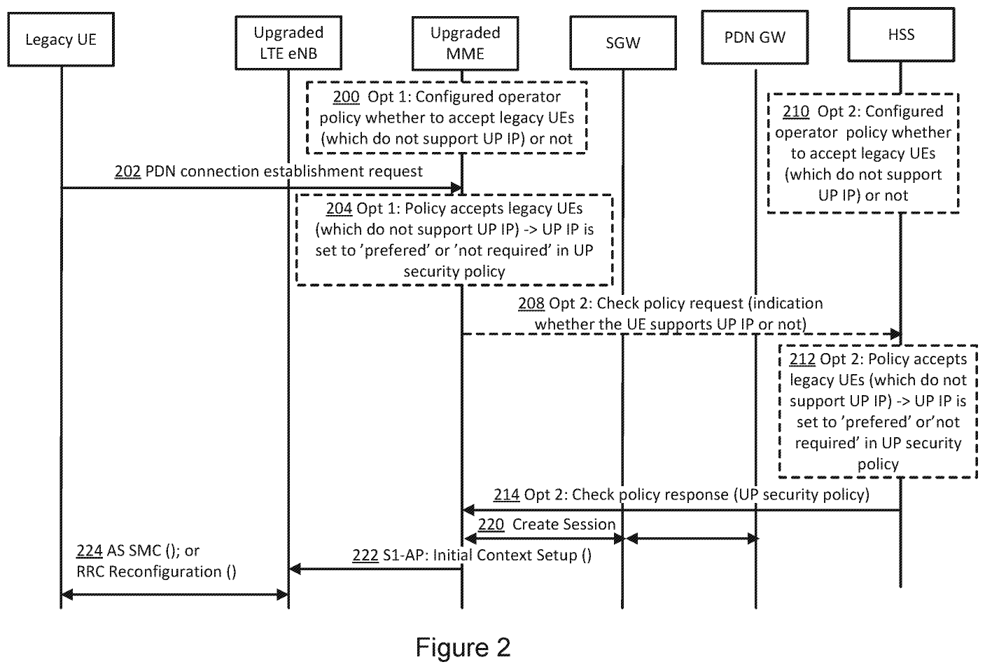

FIG. 2 is a combined flowchart and data flow diagram illustrating operations by an upgraded MME, the HSS, and other elements of a communication system operating according to Feature 1 in accordance with some embodiments.

Referring to FIG. 2, in a first alternative approach (“Opt 1”) the upgraded MME operationally configures 200 an operator policy by setting it to indicate whether to accept a legacy UE or to not accept a legacy UE. Responsive to receiving 202 a PDN connection establishment request from a legacy UE, via a upgraded LTE eNB, the upgraded MME operates to determine 204 whether the operator policy has been set (configured in step 200) to accept legacy UEs. When legacy UEs are accepted, the upgraded MME responsively sets UP IP to be either “preferred” or “not required” for the UP IP policy of the UP security policy which is part of the UP Security enforcement information for a session being established with the legacy UE. The operator policy may be accessed in local memory of the upgraded MME or accessed in a networked memory. In contrast, the upgraded MME can be configured to not accept the legacy UE if it is determined 204 that the operator policy has been set (alternately configured in step 200) to not accept legacy UEs.

Still referring to FIG. 2, in a second alternative approach (“Opt 2”) instead of or in addition to Opt 1, the upgraded MME requests the HSS to inform the upgraded MME of the UP security policy. Pursuant to the second alternative approach, the HSS operationally configures 210 the operator policy by setting it to indicate whether to accept a legacy UE or to not accept a legacy UE. The upgraded MME responds to the PDN connection establishment request 202 by sending 208 a policy request to the HSS which indicates whether the UE and/or MME supports UP IP or not and, if not, then the UE is treated as a “legacy UE.” The policy request requests the HSS to inform the MME of the UP security policy for the UE. Responsive to receiving 208 the policy request from the upgraded MME, the HSS operates to determine 204 whether the operator policy has been set (configured in step 210) to accept legacy UEs (which do not support UP IP). When the operator policy has been set to accept legacy UEs the HSS responsively sets UP IP to be either “preferred” or “not required” for the UP IP policy of the UP security policy. The HSS sends 214 a policy response containing the UP security policy (or at least the UP IP setting thereof) to the upgraded MME. The upgraded MME uses the UP security policy as part of the UP Security enforcement information for a session being established with the legacy UE.

When the PDN connection establishment request 202 from the legacy UE is accepted, then the upgraded MME, the SGW, and the PDN GW communicate to create 220 a PDU session. The upgraded MME also communicates 222 an initial context setup on S1-AP to the upgraded LTE eNB, where the communication 222 may include providing the UP IP policy setting to the upgraded LTE eNB. The upgraded LTE eNB performs 224 an AS SMC operation or RRC configuration operation with the legacy UE based in the UP IP policy setting. In contrast, when the PDN connection establishment request 202 from the legacy UE is not accepted (i.e., in a scenario where the operator policy at the time of the PDN connection establishment request 202 had not been configured to accept legacy UEs), then the steps 220 through 224 in FIG. 2 are not performed to establish a session.

A potential advantage of the operations of Feature 1 include that the operator can have a policy which indicates whether or not the MME or eNB upgraded to support UP IP is allowed to accept a legacy UE not supporting UP IP. If the configured operator policy allows the upgraded MME or upgraded eNB to handle the legacy UE, then the MME or HSS cannot determine a UP IP policy to be “required” because the UP IP cannot be activated by the eNB.

It is noted that Feature 1 can apply to 5G systems. As explained above in the background section, there is no support for the user plane integrity protection in LTE PDCP in Rel-15 UE and in a Rel-15 ng-eNB connected to an AMF in the 5G system. Various present embodiments introduce user plane integrity protection in LTE Packet Data Convergence Protocol (PDCP) in ng-eNB and UE, when connected to 5G (AMF).

A second feature, referred to as “Feature 2,” is described with operations that relate to a scenario where a network has mixed MME support for UP IP, which means that some MMEs support UP IP and some MMEs do not support UP IP. In accordance with some embodiments, the HSS can prevent activation of UP IP at PDN connection establishment by not allowing UP IP to be set to “required” in the UP security policy for any UE. The HSS can handle this by having a main operator policy which prevents HSS to set UP IP to “required” in the UP security policy for any UE.

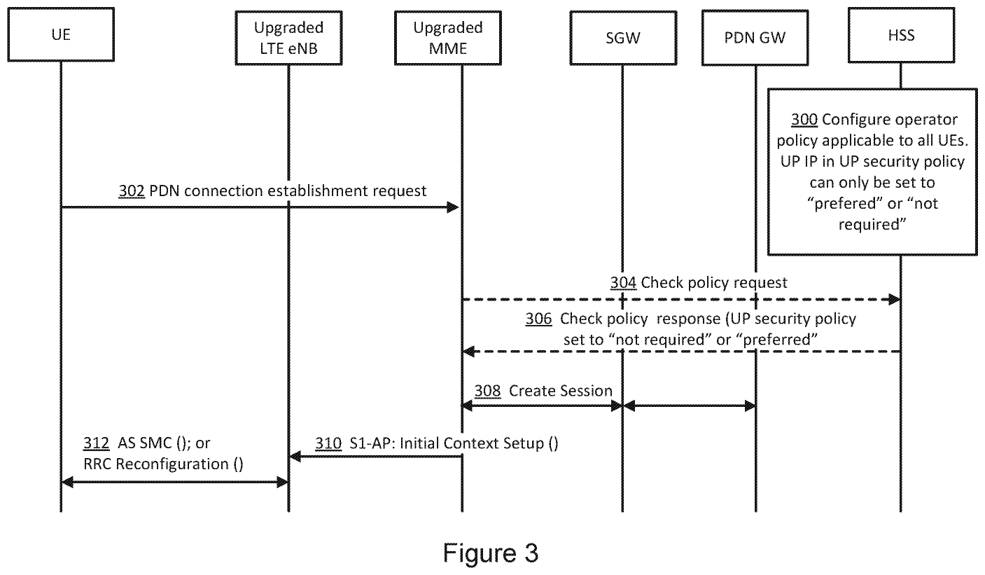

FIG. 3 is a combined flowchart and data flow diagram illustrating operations by an upgraded MME, the HSS, and other elements of the system operating according to Feature 2 in accordance with some embodiments.

Referring to FIG. 3, the HSS configures 300 an operator policy that is applicable to all UEs (also referred to as a “main operator policy”). In some embodiments when the main operator policy is to allow UP IP for legacy UEs (which do not support UP IP), the HSS sets the UP IP in the UP security policy to “preferred” or “not required”, and correspondingly prevents the UP IP from being set to “required.”

The upgraded MME responds to receipt 302 of a PDN connection establishment request from a legacy UE, via a upgraded LTE eNB, by sending 304 a check policy request (e.g., a “check UP security policy request”) to the HSS which requests the HSS to inform the MME of the UP IP setting of the UP security policy. The HSS sends 306 a check policy response (e.g., a “check UP security policy response”) indicating the UP IP setting of the UP security policy, which has been set to “preferred” or “not required” as explained above. The upgraded MME operates to accept the legacy UE for UP IP based on determining from the check UP security policy response 306 that the UP IP of the UP security policy is either “preferred” or “not required.”

When PDN connection establishment request 302 is accepted by the upgraded MME, then the upgraded MME, the SGW, and the PDN GW communicate to create 308 a session. The upgraded MME also communicates 310 an initial context setup on S1-AP to the upgraded LTE eNB, where the communication 310 may include providing the UP IP policy setting to the upgraded LTE eNB. The upgraded LTE eNB performs 312 an AS SMC operation or RRC configuration operation with the legacy UE based on the UP IP policy setting.

A potential advantage of the operations of Feature 2 include that in a network with mixed MME support for UP IP (i.e., some MMEs support UP IP and some MMEs do not support UP IP), the HSS can operate to prevent activation of UP IP at PDN connection establishment by not allowing UP IP to be set to “required” in the UP security policy for any UE. The HSS can handle this using the main operator policy which prevents HSS from setting UP IP to “required” in the UP security policy for any UE.

A third feature, referred to as “Feature 3,” is described with operations that relate to a scenario during MME change (at handover and/or at registration update), if the source MME and the source eNB are upgraded to support UP IP, then the source MME or the source eNB operate to ensure that a PDN connection (e.g., existing already established PDN connection) with activated UP IP and with an UP security policy setting of UP IP to “required” in the UP security policy, is not handed over to a target MME or a target eNB which does not support UP IP.

In one embodiment of Feature 3, the source MME operates to reject the handover of the PDN connection with activated UP IP based on the UP IP of the UP security policy being set to “required” and based on determining that the target MME does not support UP IP.

In another embodiment of Feature 3, the target MME and/or the target eNB operate to reject the handover of the PDN connection with activated UP IP based on the UP IP of the UP security policy setting being set to “required” and based on determining that the target MME and/or the target eNB does not support UP IP.

In another embodiment of Feature 3, the source MME operates to deactivate UP IP in the UP security policy setting by, e.g., changing the current setting of “required” to instead be either “preferred” or “not needed” in the UP security policy for the PDN connection, so that the handover can proceed to the target MME and target eNB. This change operation may be performed based on the source MME and the source eNB being configured to support UP IP and a determination that the PDN connection has an activated UP IP, and further based on the UP IP of the UP security policy being formerly set to “required” and the hand over being to a target MME or a target eNB which does not support UP IP.

Thus in the embodiments of Feature 3, a MME (source MME or target MME) or HSS of FIG. 2 or the HSS of FIG. 3 can initiate the source MME to reject handover of a PDN connection request from the legacy UE based on the UP IP of the UP security policy being set to “required.”

A fourth feature, referred to as “Feature 4,” is described with operations that relate to a scenario where a legacy UE not supporting UP IP initiates a PDU session with a 5G system where an upgraded ng-eNB supports UP IP and is connected to an upgraded Access and Mobility Management Function (AMF). The SMF already supports the handling of the feature UP IP since Rel-15. The legacy UE can either be: 1) handled by the SMF and the ng-eNB in the legacy way as described in Rel-16 specifications and in this case the SMF and the ng-eNB cannot activate UP IP with such a legacy UE; or 2) the SMF or the UDM can reject such a legacy UE.

Whether the legacy UE is to be handled in a legacy way can be decided based on a configured operator policy defining whether legacy UEs are to be handled in a legacy way by the upgraded AMF, a Session Management Function (SMF), and the ng-eNB. If the configured operator policy allows the upgraded AMF, the SMF, and the upgraded ng-eNB to handle the legacy UE, then the SMF or a Unified Data Management (UDM) cannot determine an UP IP policy (in an UP security policy) to be “required” because UP IP cannot be activated by the ng-eNB for the legacy UE which does not support UP IP.

This operator policy can be configured in the UDM, configured in the SMF, or configured in the AMF.

If operator policy is configured in the AMF, then the AMF can determine already during the Registration procedure whether it will accept or reject the legacy UE.

As explained above, “legacy UE” means that the UE does not support UP integrity protection. The AMF, SMF or the UDM can identify whether a UE is a legacy UE not supporting UP IP by checking the mobile equipment (ME) capability which indicates whether the ME supports UP integrity protection or not, and this ME capability is indicated by the UE/ME already in Registration Request message.

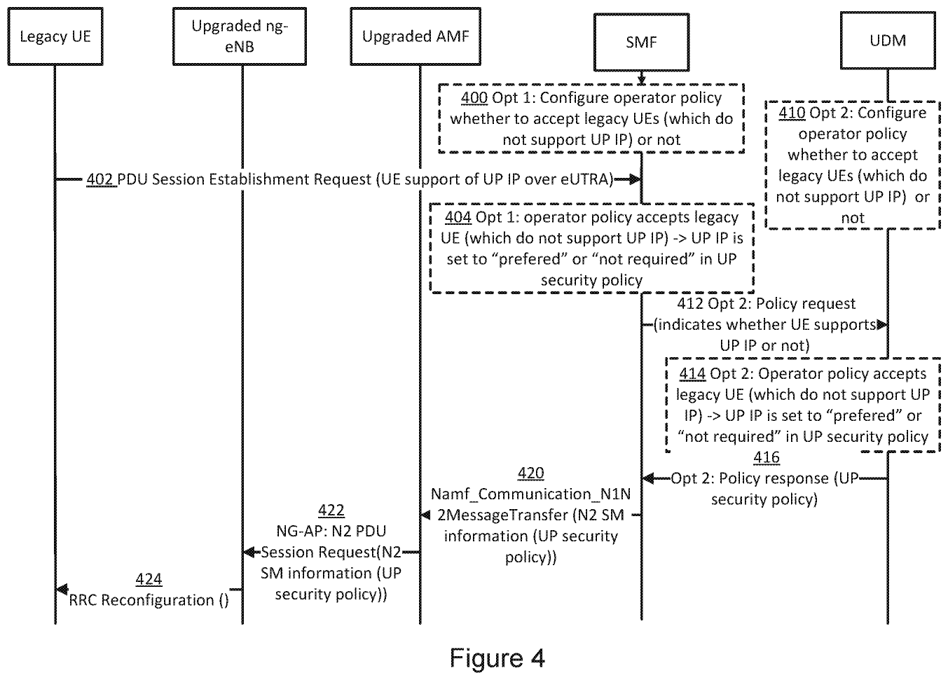

FIG. 4 is a combined flowchart and data flow diagram illustrating operations by an upgraded ng-eNB, an upgraded AMF, a SMF, and a UDM, and other elements of the system operating according to Feature 4 in accordance with some embodiments.

Referring to FIG. 4, in a first alternative (“Opt 1”) the SM operationally configures 400 an operator policy by setting it to indicate whether to accept a legacy UE or to not accept a legacy UE. Responsive to receiving 402 a PDU session establishment request from a legacy UE, via a upgraded ng-eNB, the SMF operates to determine 404 whether the operator policy has been set (configured in step 400) to accept legacy UEs. When legacy UEs are accepted, the SMF responsively sets UP IP to be either “preferred” or “not required” for the UP IP policy of the UP security policy which may be part of the UP Security enforcement information for the PDU session being established with the legacy UE. The operator policy may be accessed in local memory of the SMF or accessed in a networked memory. In contrast, the SMF can be configured to not accept the legacy UE if it is determined 404 that the operator policy has been set (configured in step 400) to not accept legacy UEs.

Still referring to FIG. 4, in a second alternative approach (“Opt 2”) instead of or in addition to Opt 1, the SMF requests the UDM to inform the SMF of the UP security policy. Pursuant to the second alternative approach, the UDM operationally configures 410 the operator policy by setting it to indicate whether to accept a legacy UE or to not accept a legacy UE. The SMF responds to the PDN connection establishment request 402 by sending 412 a policy request to the UDM which identifies whether the UE/ME supports UP IP or not over E-UTRA. If the UE/ME does not support UP IP then the UE is treated as a “legacy UE.” The policy request requests the UDM to inform the SMF of the UP security policy. Responsive to receiving 412 the policy request from the SMF, the UDM operates to determine 414 whether the operator policy has been set (configured in step 410) to accept legacy UEs. When the operator policy has been set to accept legacy UEs the UDM responsively sets UP IP to be either “preferred” or “not required” for the UP IP policy of the UP security policy. The UDM sends 416 a policy response containing the UP security policy (or at least the UP IP setting thereof) to the SMF. The SMF uses the UP security policy as part of the UP Security enforcement information for a PDU session being established with the legacy UE.

When the PDN connection establishment request 402 from the legacy UE is accepted, then the SMF sends 420 an Namf_Communication_N1N2MessageTransfer (N2 SM information (UP security policy)) to the upgraded AMF. The upgraded AMF then sends 422 NG-AP: N2 PDU Session Request (N2 SM information (UP security policy)) to the upgraded ng-eNB. The communications 420 and 422 may include providing the UP IP policy setting to the upgraded ng-eNB. The upgraded ng-eNB then sends 424 a RRC Reconfiguration to the legacy UE, which may be based on the UP IP policy setting.

A potential advantage of the operations of Feature 4 can include that the operator can define and update a policy which indicates whether the AMF/SMF and the upgraded ng-eNB to support UP IP, are allowed or not allowed to handle a legacy UE that does not support UP IP. When the configured operator policy allows the AMF/SMF and the upgraded ng-eNB to handle the legacy UE, then the SMF or UDM cannot determine a UP IP policy to “required” because UP IP cannot be activated by the ng-eNB.

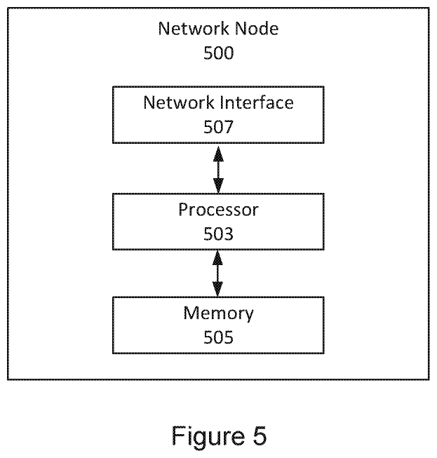

FIG. 5 is a block diagram illustrating components of a network node 500 operable according to some embodiments of the present disclosure. The network node 500 which may be configured to implement any of the eNB, MME, SGW, PDN GW, HSS, AMF, SMF, and/or UDM and contain elements that are configured according to one or more embodiments disclosed herein. The network node 500 can include one or more network interfaces 507 referred to as “network interface” for brevity, one or more processors 503 referred to as “processor” for brevity, and one or more memories 505 referred to as “memory” for brevity containing instructions executable by the processor 503.

The network interface 507 may be configured to communicate through a wired interface, e.g., Ethernet, and/or wireless interface, e.g., wireless transceiver, according to one or more proprietary protocols and/or industry standardized protocols, e.g., WiFi, 3GPP 4G, 5G NR, etc. The processor 503 may include one or more data processing circuits, such as a general purpose and/or special purpose processor e.g., microprocessor and/or digital signal processor that may be collocated or distributed across one or more networks. The processor 503 is configured to execute instructions in the memory 505, described below as a computer readable medium, to perform some or all of the operations and methods that are described above for one or more of the embodiments of a eNB, MME, SGW, PDN GW, HSS, AMF, SMF, and/or UDM, such as regarding one or more of the embodiments described herein.

In the above description, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following examples of embodiments and their equivalents, and shall not be restricted or limited by the foregoing detailed description.

The following 3GPP TSG-SA3 Meeting #100e document is part of may be incorporated anywhere within the present disclosure in accordance with various embodiments.

3GPP TSG-SA3 Meeting #100e S3-20xxxx

e-meeting, 17-28 Aug. 2020 Revision of S3-20xxxx

Source: Ericsson

Title: UPIP: Update to solution #11 (UP IP over eUTRA connected to EPS)

Document for: Approval

Agenda Item: ???

### 1 Decision/Action Requested

This contribution proposes an update to solution #11.

### 2 References

[1] 3GPP TR 33.853 “Integrity protection of the User Plane”.

### 3 Rationale

Introducing UP IP over eUTRA connected to EPS, is problematic as legacy UE's and legacy network nodes needs to be considered.

### 4 Detailed Proposal

It is proposed to update solution #11 about legacy UE's and legacy network nodes to the study in W.

****START OF CHANGES****

6.11 Solution #11: Support of UP IP in EPS

6.11.1 Introduction

This solution addresses key issue #1 (UP integrity activation in EPS). A UE which has been upgraded to support UP IP over LTE access, when connected to EPS, needs to indicate UE support of UP IP to the network.

This solution impacts the UE, the MME, the HSS and the LTE eNB.

6.11.2 Network options affected

This solution is applicable to the following network options:
Option 1—eUTRA with EPC
Option 3—EPC based Dual Connectivity of eUTRA and NR RAT

6.11.3 Solution Description

The UE capability to support UP IP over LTE access when connected to EPS could be indicated in Attach Request and Tracking Area Update Request message. A new IE could be included in the Attach Request message and Tracking Area Update Request message. The new IE would need to be mapped on the S1 interface to the LTE eNB.

The transfer of the new IE would also have impact on S10 interface between MME's. For coexistence with legacy nodes then support needs to be signalled by the UE again during mobility procedures at MME change, but this should not be a problem as the UE would initiate a new Tracking Area Update procedure at MME change anyway. Also, its not envisioned that the LTE eNB would be upgraded, without upgrading the MME as well.

The MME could apply/request use of UP IP at PDN Connection establishment (on par with 5GS). UP IP would then be applied per PDN connection lifetime.

The MME could configure a security policy for UP IP i.e. a UP IP policy, per APN and/or the MME could determine the UP IP policy by potentially retrieving a UP IP policy for the subscription stored in the HSS or from the locally configured UP IP policy. The determined UP IP policy would be configured per UE. The UP IP policy could use similar setting options as in 5GS: “required”, “preferred”, “not needed”.

The MME provides the determined UP IP policy per UE to the LTE eNB on the S1 interface.

The UP IP policy could be extended to a UP security policy which includes a security policy for UP encryption as well. This would harmonize the feature over both systems (EPS and 5GS).

The enabling/disabling of UP IP for DRB's is done using AS SMC procedure and RRC Reconfiguration procedure, similar as in NR.

6.11.x Handling of Legacy UE's and Legacy Network Nodes in EPS

It is expected that if the eNB is upgraded to support UP IP, then the connected MME is upgraded as well to support the UP security policy (i.e. UP IP). A legacy eNB which is not supporting UP IP, is most likely connected to MME which is not supporting the UP security policy (i.e. UP IP).

Legacy UE's:

A legacy UE which establishes a new PDN connection with an upgraded MME and an upgraded eNB which supports UP IP, should be handled by the MME and the eNB in the legacy way, and this decision could be based upon a configured operator policy. If the configured operator policy allows the upgraded MME/eNB to handle the legacy UE, then the MME cannot determine a UP IP policy to “required” as UP IP cannot be activated by the eNB.

Legacy Network Nodes:

An upgraded UE supporting UP IP, which establishes a new PDN connection with a legacy MME, UP IP cannot be activated by the eNB (even if the eNB supports UP IP).

Mixed MME support for UP IP:

As an option, in a network with mixed MME support for UP IP, the HSS could prevent activation of UP IP “required” PDN connections.

Mobility:

At MME change (both at handover and registration update), then if the source MME and the source eNB are upgraded to support UP IP, then the source MME/source eNB shall ensure that the PDN connection with activated UP IP is not handed over to a target MME or a target eNB which does not support UP IP.

Alternatively, homogeneous MME support is required for a network that allows UP IP “required” PDN connection.

6.11.y Solution Evaluation

Editor's Note: write an evaluation of the solution against the relevant key issues here (or have an editor's note saying that it is to be added later.)

This solution meets the security requirement for key issue #1 (UP integrity activation in EPS) and impacts the UE, the MME, the LTE eNB and the HSS.

A legacy UE which establishes a new PDN connection with an upgraded MME and an upgraded eNB which supports UP IP, should be handled by the MME and the eNB in the legacy way, and this decision could be based upon a configured operator policy. If the configured operator policy allows the upgraded MME/eNB to handle the legacy UE, then the MME cannot determine a UP IP policy to “required” as UP IP cannot be activated by the eNB.

An upgraded UE supporting UP IP, which establishes a new PDN connection with a legacy MME, UP IP cannot be activated by the eNB (even if the eNB supports UP IP).

As an option, in a network with mixed MME support for UP IP, the HSS could prevent activation of UP IP “required” PDN connections.

At MME change (both at handover and registration update), then if the source MME and the source eNB are upgraded to support UP IP, then the source MME/source eNB shall ensure that the PDN connection with activated UP IP is not handed over to a target MME or a target eNB which does not support UP IP.

Alternatively, homogeneous MME support is required for a network that allows UP IP “required” PDN connection.

1. A method of operating a network node in a wireless communication system, comprising:
configuring an operator policy to indicate whether to accept legacy user equipments, UEs, that do not support user plane integrity protection, UP IP; and
setting UP IP to be either “preferred” or “not required” of a UP security policy based on the operator policy indicating acceptance of legacy UEs and in response to a communication related to a legacy UE.

2. The method of claim 1, wherein the configuring of the operator policy is performed by a mobility management entity, MME, and the setting of the UP IP is responsive to receiving a PDN connection establishment request of the legacy UE.

3. The method of claim 1, further comprising communicating the UP IP policy setting to an LTE eNB based on the operator policy indicating acceptance of legacy UEs.

4. The method of claim 1, wherein the configuring of the operator policy is performed by a home subscriber server, HSS, and the setting of the UP IP is responsive to receiving a check policy request indicating whether the legacy UE supports UP IP or not.

5. The method of claim 4, further comprising sending a check policy response containing the UP security policy responsive to the check policy request.

6. The method of claim 1, wherein the configuring of the operator policy is performed by a home subscriber server, HSS, and sets the UP IP in the UP security policy to “preferred” or “not required,” and prevents the UP IP in the UP security policy from being set to “required.”

7. The method of claim 6, further comprising sending a check policy response containing the UP IP of the UP security policy responsive to receiving a check policy request.

8. The method of claim 1, further comprising:
initiating a MME to reject handover of a PDN connection request from the legacy UE based on the UP IP of the UP security policy being set to “required.”

9. The method of claim 1, wherein the configuring of the operator policy is performed by a session management function, SMF, and the setting of the UP IP is responsive to receiving a PDU session establishment request of the legacy UE.

10. The method of claim 9, further comprising communicating the UP IP policy setting to a ng-eNB based on the operator policy indicating acceptance of legacy UEs.

11. The method of claim 1, wherein the configuring of the operator policy is performed by a unified data management, UDM, and the setting of the UP IP is responsive to receiving a policy request from a session management function, SMF, indicating whether the legacy UE supports UP IP or not.

12. The method of claim 11, further comprising sending a policy response containing the UP security policy to the SMF responsive to the policy request.

13. A network node, comprising:
at least one processor and memory collectively configured to:
configure an operator policy to indicate whether to accept legacy user equipments, UEs, that do not support user plane integrity protection, UP IP; and
set UP IP to be either “preferred” or “not required” of a UP security policy based on the operator policy indicating acceptance of legacy UEs and in response to a communication related to a legacy UE.

14. The network node of claim 13, wherein the network node comprises a mobility management entity, MME, and the setting of the UP IP is responsive to receiving a PDN connection establishment request of the legacy UE.

15. The network node of claim 13, wherein the at least one processor and memory are collectively further configured to communicate the UP IP policy setting to an LTE eNB based on the operator policy indicating acceptance of legacy UEs.

16. The network node of claim 13, wherein the network node comprises a home subscriber server, HSS, and the setting of the UP IP is responsive to receiving a check policy request indicating whether the legacy UE supports UP IP or not.

17. The network node of claim 16, wherein the at least one processor and memory are collectively further configured to send a check policy response containing the UP security policy responsive to the check policy request.

18. The network node of claim 13, wherein the network node comprises a home subscriber server, HSS, and the configuring of the operator policy sets the UP IP in the UP security policy to “preferred” or “not required,” and prevents the UP IP in the UP security policy from being set to “required.”

19. The network node of claim 18, wherein the at least one processor and memory are collectively further configured to send a check policy response containing the UP IP of the UP security policy responsive to receiving a check policy request.

20. The network node of claim 13, wherein the at least one processor and memory are collectively further configured to initiate a MME to reject handover of a PDN connection request from the legacy UE based on the UP IP of the UP security policy being set to “required.”

21. The network node of claim 13, wherein the network node comprises a session management function, SMF, and the setting of the UP IP is responsive to receiving a PDU session establishment request of the legacy UE.

22. The network node of claim 21, wherein the at least one processor and memory are collectively further configured to communicate the UP IP policy setting to a ng-eNB based on the operator policy indicating acceptance of legacy UEs.

23. The network node of claim 13, wherein the network node comprises a unified data management, UDM, and the setting of the UP IP is responsive to receiving a policy request from a session management function, SMF, indicating whether the legacy UE supports UP IP or not.

24. The network node of claim 23, wherein the at least one processor and memory are collectively further configured to send a policy response containing the UP security policy to the SMF responsive to the policy request.
